(19) United States
(12) Patent Application Publication
(10) Pub. No.: US 2025/0121620 A1
(43) Pub. Date: Apr. 17, 2025

(54) PRINTING APPARATUS, CONTROL METHOD, AND STORAGE MEDIUM

(71) Applicant: CANON KABUSHIKI KAISHA, Tokyo (JP)

(72) Inventor: TAKUJI FUKUMOTO, Tokyo (JP)

(21) Appl. No.: 18/906,427

(22) Filed: Oct. 4, 2024

(30) Foreign Application Priority Data
Oct. 12, 2023 (JP) 2023-176524

(51) Int. Cl. B41J 29/393; B41J 2/165

(52) U.S. Cl. CPC B41J 29/393; B41J 2/16508

(57) ABSTRACT

Provided is a technology capable of efficiently executing a process that is executed by multiple operations involving driving and a different process based on electric power supplied. A printing apparatus capable of operating with electric power supplied through a USB cable includes: an obtaining unit configured to obtain information on a value of electric power supplied through the USB cable; and a control unit configured to control execution of a first process and a second process based on the information obtained by the obtaining unit, the first process being a process to be implemented by a plurality of operations that are executed using a driving force from a driving source transmitted through a mechanical mechanism, the second process being a process related to a setting.

### BACKGROUND OF THE INVENTION

### Field of the Invention

The present invention relates to a printing apparatus, a control method, and a storage medium.

### Description of the Related Art

Heretofore, printing apparatuses that operate with electric power supplied through a universal serial bus (USB) cable have been known. Japanese Patent Laid-Open No. 2013-166294 discloses a technology for such a printing apparatus in which three operations involving driving that are executed during a printing process are varied in timing to create modes differing in the peak value of the amount of power consumption, and a mode corresponding to the amount of electric power supplied through a USB cable is selected.

Also, a printing apparatus as disclosed in Japanese Patent Laid-Open No. 2019-001106 capable of connecting to a terminal apparatus, such as a personal computer (PC), by communication has been known. The printing apparatus disclosed in Japanese Patent Laid-Open No. 2019-001106 executes a setting process of setting a communication mode for communicatively connecting the printing apparatus to a terminal apparatus and also executing a cleaning process on the print head at a timing such as when an initial setup is performed.

However, Japanese Patent Laid-Open No. 2013-166294 does not disclose a technology for executing a process that is implemented by multiple operations involving driving, such as the cleaning process, and a process related to a setting, such as setting a communication mode, according to the electric power supplied.

### SUMMARY OF THE INVENTION

The present invention has been made in view of the above problem, and provides a technology capable of executing a process that is implemented by multiple operations involving driving and a process related to a setting based on electric power supplied.

A printing apparatus capable of operating with electric power supplied through a USB cable, the printing apparatus includes: an obtaining unit configured to obtain information on a value of electric power supplied through the USB cable; and a control unit configured to control execution of a first process and a second process based on the information obtained by the obtaining unit, the first process being a process to be implemented by a plurality of operations that are executed using a driving force from a driving source transmitted through a mechanical mechanism, the second process being a process related to a setting.

In accordance with the present invention, it is possible to execute a process which is to be executed by multiple operations involving driving and a process related to a setting based on supplied electric power.

Further features of the present invention will become apparent from the following description of exemplary embodiments with reference to the attached drawings.

### BRIEF DESCRIPTION OF THE DRAWINGS

FIG. 1 is a schematic configuration diagram of a printing system;

FIG. 2 is a block diagram illustrating a configuration of a control system in the printing apparatus;

FIG. 3 is a block diagram illustrating a configuration of a power supply control circuit;

FIG. 4 is a schematic configuration diagram of a printing part;

FIG. 5 is a schematic configuration diagram of a PC terminal;

FIG. 6 is a flowchart illustrating details of processing in a connection setting process;

FIG. 7 is a flowchart illustrating details of processing in a switching process;

FIG. 8 is a schematic configuration diagram of a printing system including a printing apparatus according to a second embodiment;

FIG. 9 is a flowchart illustrating details of processing in a switching process in the second embodiment; and

FIG. 10 is a flowchart illustrating details of processing in a switching process in a third embodiment.

### DESCRIPTION OF THE EMBODIMENTS

Examples of embodiments of a printing apparatus, a control method, and a storage medium will be described below with reference to the accompanying drawings. Note that the following embodiments do not limit the present invention, and not all the combinations of the features described in these embodiments are necessarily essential for the solution to be provided by the present invention. Moreover, the positions, shapes, and the like of the constituent elements described in the embodiments are mere examples, and there is no intension to limit the present invention only to these.

### First Embodiment

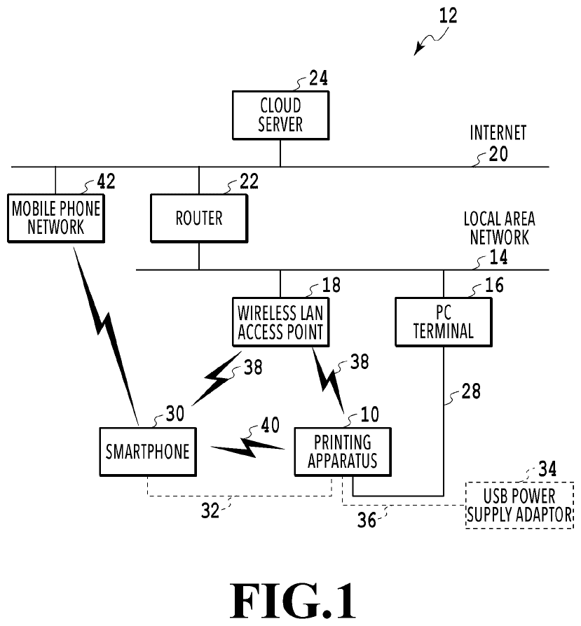

First, a printing apparatus according to a first embodiment will be described with reference to FIGS. 1 to 7.

### <Printing System>

FIG. 1 is a schematic configuration diagram illustrating a printing system including the printing apparatus according to the present embodiment. A printing system 12 including a printing apparatus 10 according to the present embodiment includes the printing apparatus 10, which performs printing by ejecting inks, and a PC terminal 16 as an external apparatus connected to the printing apparatus 10 through a local area network (LAN) 14. Note that the printing system 12 includes a wireless LAN access point 18, and the printing apparatus 10 can connect to the LAN 14 by wirelessly connecting to the wireless LAN access point 18. The printing system 12 also includes a router 22 for connecting the LAN 14 to an Internet 20, and a cloud server 24 connected to the Internet 20. In this way, the printing apparatus 10 and the PC terminal 16 can communicate with the cloud server 24 connected to the Internet 20 through the router 22.

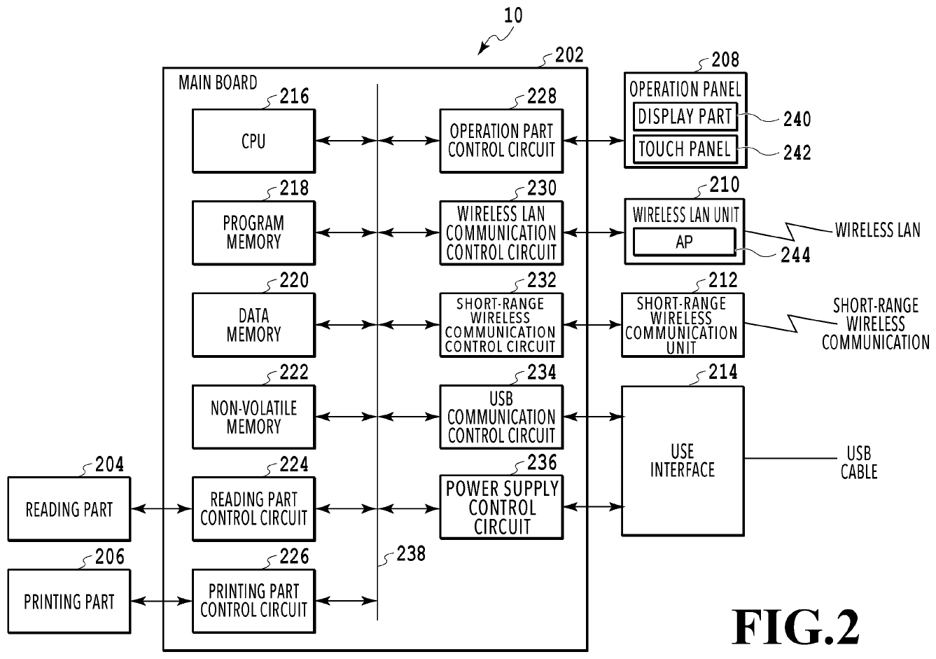

The printing apparatus 10 includes a USB interface 214 (see FIG. 2) and is configured to be connectable to various apparatuses. In the present embodiment, the printing apparatus 10 includes a USB interface 214 to which a USB cable is connectable, and is connected to the PC terminal 16 through a USB cable 28. In this way, the printing apparatus 10 is capable of operating with electric power supplied from the PC terminal 16 through the USB cable 28. As described above, in the present embodiment, a USB cable including the USB cable 28 functions as a connection member that connects the printing apparatus 10 and an external apparatus to each other.

Also, in the printing system 12, a smartphone 30 can be used as an external apparatus. In this case, the smartphone 30 and the printing apparatus 10 are connected through a USB cable 32, and the printing apparatus 10 can operate with electric power supplied from the smartphone 30. Moreover, in the printing system 12, the printing apparatus 10 and a USB power supply adaptor 34 are connected through a USB cable 36, and the printing apparatus 10 can operate with electric power supplied from a commercial power source. Incidentally, while not illustrated, the printing apparatus 10 is configured to be capable of operating with electric power supplied from a mobile battery, a USB host port installed in a seat on an airplane or a bus, or the like through a USB cable.

The smartphone 30 and the printing apparatus 10 use wireless LAN infrastructure mode connections 38 with the wireless LAN access point 18. The printing apparatus 10 has a mode in which it operates as a wireless LAN access point. In a case where the printing apparatus 10 operates as an access point, the smartphone 30 can directly connect to the printing apparatus 10 (direct connection 40). Also, the smartphone 30 is capable of connecting to the cloud server 24, which is connected to the Internet 20, through a mobile phone network 42.

In a case where the printing apparatus 10 is connected to the PC terminal 16 and the smartphone 30 by USB cables, the USB cables can be used for data communication between the printing apparatus 10 and the PC terminal 16 and the smartphone 30, but the data communication is not limited to this. The printing apparatus 10 can operate with electric power supplied from the PC terminal 16 and the smartphone 30 connected thereto by USB cables, and data communication can be executed using a wireless LAN and/or short-range wireless communication. Note that the printing system 12 illustrated in FIG. 1 is an example of the printing system including the printing apparatus 10 according to the present embodiment, and may have a configuration different from the configuration illustrated in FIG. 1. For example, instead of the wireless LAN access point 18 and the router 22, a single configuration having these functions, e.g., a router having an access point function, may be used.

### <Configuration of Control System in Printing Apparatus>

Next, a configuration of a control system in the printing apparatus 10 will be described. FIG. 2 is a block diagram illustrating a configuration of the control system in the printing apparatus 10.

The printing apparatus 10 includes a main board 202 which performs comprehensive control of the printing apparatus 10, a reading part 204 which reads documents, a printing part 206 which performs printing on print media, and an operation panel 208 with which the user can perform operations. The printing apparatus 10 also includes a wireless LAN unit 210 for connecting to a wireless LAN, a short-range wireless communication unit 212 for performing short-range wireless communication, and the USB interface 214, which can be connected to a USB cable.

The main board 202 includes a central processing unit (CPU) 216 in the form of a microprocessor, a program memory 218 in the form of a read-only memory (ROM), a data memory 220 in the form of a random-access memory (RAM), and a non-volatile memory 222 capable of holding information saved therein even with no power supply. Also, the main board 202 includes a reading part control circuit 224 for controlling the reading part 204, a printing part control circuit 226 for controlling the printing part 206, and an operation part control circuit 228 for controlling the operation panel 208. Further, the main board 202 includes a wireless LAN communication control circuit 230 for controlling the wireless LAN unit 210, and a short-range wireless communication control circuit 232 for controlling the short-range wireless communication unit 212. Furthermore, the main board 202 includes a USB communication control circuit 234 that controls the driving of the USB interface 214, and a power supply control circuit 236 that controls the amount of electric power to be supplied from the USB interface 214. The components provided in the main board 202 are connected to one another by an internal bus 238.

The CPU 216 operates using the data memory 220 as a work area based on a control program stored in the program memory 218 and information held in the data memory 220. Also, by writing various setting values, data, and the like to the non-volatile memory 222, the CPU 216 can continuously operate in a case where the power source is turned off and then turned on again based on the setting values and data written to the non-volatile memory 222. A semiconductor storage device such as a flash memory can be used as the non-volatile memory 222, for example. While flash memories are capable of retaining contents stored therein even after the power supply is stopped, the number of times each memory element can be rewritten tends to be limited. For this reason, the design needs to be determined with the timing to write data to the non-volatile memory 222 in the product life of the printing apparatus 10 taken into account. Generally, the unit price of a storage device tends to be more expensive the larger the guaranteed number of times the device can be rewritten.

The CPU 216 controls the reading part 204 via the reading part control circuit 224 to read a document and stores the read data in the data memory 220 as image data. Further, the CPU 216 controls the printing part 206 via the printing part control circuit 226 to perform printing on a print medium based on print data obtained by performing image processing on image data stored in the data memory 220. Also, the CPU 216 can display the state of the printing apparatus 10 and display selectable functions in the form of a menu on a display part 240 and a touch panel 242 provided to the operation panel 208 and accept the user's operations on the display part 240 and the touch panel 242, for example, by controlling the operation part control circuit 228.

The CPU 216 performs wireless LAN communication with other communication terminal apparatuses by controlling the wireless LAN unit 210 via the wireless LAN communication control circuit 230. Note that the wireless LAN unit 210 includes an access point 244 for connecting to external apparatuses (information processing apparatuses to be described later) and the like. An “access point” will be referred to as “AP” herein as appropriate. Also the CPU 216 detects connections to other short-range wireless communication terminals and transmitting and receiving data to and from the other short-range wireless communication terminals by controlling the short-range wireless communication unit 212 via the short-range wireless communication control circuit 232. Further, the CPU 216 causes the USB interface 214 to operate via the USB communication control circuit 234 to perform USB communication with another external apparatus connected thereto by a USB cable. Furthermore, the CPU 216 keeps track of and controls the amount of electric power supplied from the USB interface 214 and the amount of electric power stored in the power supply control circuit 236 by controlling the power supply control circuit 236.

### <Configuration of Power Supply System in Printing Apparatus>

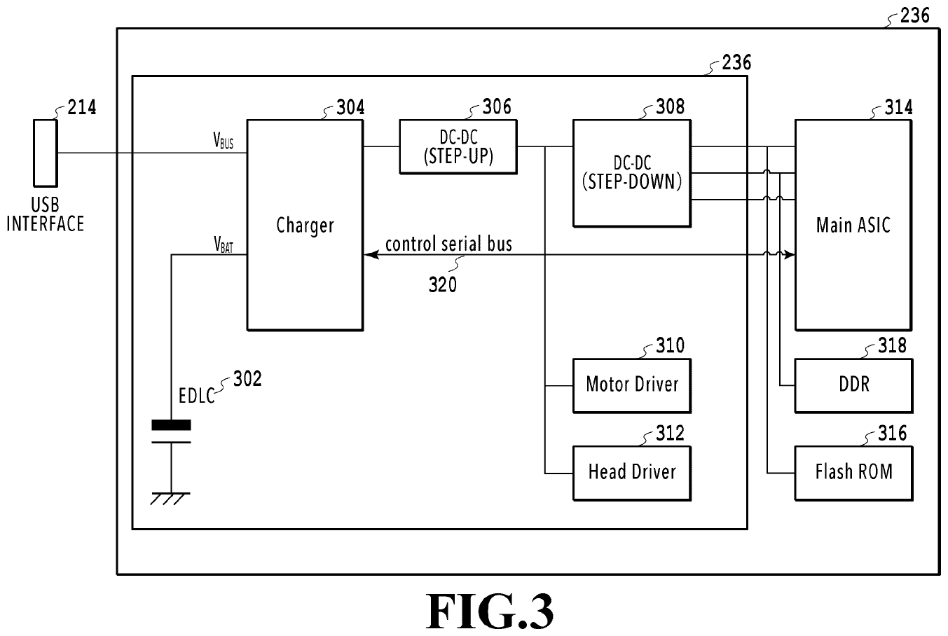

Next, a configuration of a power supply system in the printing apparatus 10 will be described. FIG. 3 is a block diagram illustrating the configuration of the power supply system in the printing apparatus 10.

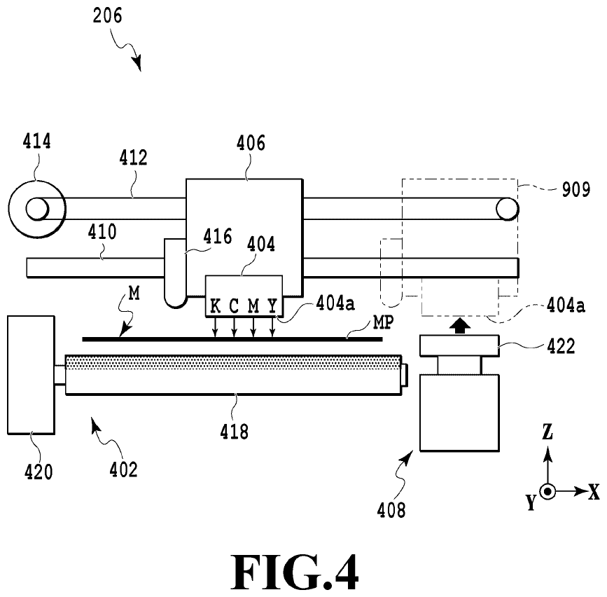

The power supply control circuit 236 includes an electrical double layer capacitor (EDLC) 302 that is capable of storing and supplying electric power, and a charger 304 that performs control of a current input therein and the like. Also, the power supply control circuit 236 includes a DC-DC (step-up) 306 being a booster circuit for raising a voltage from the charger 304, and a DC-DC (step-down) 308 being a buck circuit that lowers a voltage output from the DC-DC 306. Further, the power supply control circuit 236 includes a motor driver 310 that drives motors in the reading part 204 and the printing part 206, and a head driver 312 that drives a reading head (not illustrated) and a print head 404 (see FIG. 4).

The printing apparatus 10 is capable of being driven with an output voltage V_{BUS} from the USB interface 214 and an output voltage V_{BAT} from the EDLC 302, and the power supply is controlled by the charger 304. The voltage output from the charger 304 is raised by the DC-DC (step-up) 306, and the voltage raised by the DC-DC 306 is used by the motor driver 310 to drive the motors of the reading part 204 and the printing part 206. Also, the voltage raised by the DC-DC 306 is used by the head driver 312 to drive the reading head of the reading part 204 and the print head 404 of the printing part 206. The voltage raised by the DC-DC 306 is input into the DC-DC 308 to generate a logic power supply voltage to be used in an application-specific integrated circuit (ASIC) 314, a ROM 316, and a double data rate synchronous dynamic random-access memory (DDR SDRAM) 318.

The charger 304 is a unit having a function of controlling the power supply, controlling the power discharge and charging of the EDLC 302, managing the remaining amount of electric power in the EDLC 302, and protecting the EDLC 302 from abnormal operations. Also, the charger 304 is connected to the ASIC 314 through a control serial bus 320. The charger 304 cannot execute a USB enumeration process (hereinafter referred to simply as “enumeration process” as well), and the ASIC 314 connected to the charger 304 executes the enumeration process. For example, in a case where the PC terminal 16 is connected to the USB interface 214, the ASIC 314 performs an enumeration process with the PC terminal 16 and, based on the result of the process, outputs an instruction to perform control for changing the charging current of the EDLC 302 to the charger 304. In the present embodiment, for example, the charger 304 performs a determination complying with a USB-Battery Charging (BC) standard and a determination complying with a USB-Power Delivery (PD) standard. The charger 304 automatically controls the supply of the output voltage V_{BUS} and the output voltage V_{BAT} to a load of the printing apparatus 10.

The EDLC 302 is a rechargeable battery and discharges electric power in response to an instruction from the charger 304 according to the load of the printing apparatus 10. For example, in a case where the charger 304 determines that the output voltage V_{BUS} from the USB interface 214 is not enough to execute a printing operation when the printing apparatus 10 is to perform the printing operation, the output voltage V_{BAT} at the EDLC 302 is used to execute the printing operation. For the charging control, there are a host control mode in which the charging control is executed based on an instruction output from the ASIC 314 to the charger 304 through the control serial bus 320, and an automatic mode in which the charger 304 itself executes the charging control. In the present embodiment, the EDLC 302 functions as an electric power storage part capable of storing supplied electric power.

The ASIC 314 is capable of obtaining information on the remaining amount of electric power in the EDLC 302 through a level sense (not illustrated). Also, the ASIC 314 causes the printing part 206 to temporarily stop operating, for example, in a case where the printing part 206 is booted using the output voltage V_{BAT} from the EDLC 302 and the amount of electric power stored in the EDLC 302 runs out. Then, the ASIC 314 causes the printing part 206 to resume operating after the amount of electric power stored in the EDLC 302 exceeds to a certain amount as a result of the charging control by the charger 304. Note that the printing apparatus 10 also uses electric power for, for example, wireless communication by the wireless LAN unit 210 and display on the display part 240 and the touch panel 242 of the operation panel 208, and electric power is supplied to the related members, as in the operation of the printing part 206.

### <Configuration of Printing Part in Printing Apparatus>

Next, a configuration of the printing part 206 in the printing apparatus 10 will be described. Note that various publicly known components can be used for the reading part 204 in the printing apparatus 10, and description thereof is therefore omitted. FIG. 4 is a schematic diagram of the configuration of the printing part 206.

The printing part 206 includes a conveyance part 402 which conveys a print medium M in a Y direction, and the print head 404, which ejects inks onto the print medium M conveyed by the conveyance part 402 to perform printing. Also, the printing part 206 includes a carriage 406 on which the print head 404 is mounted and which is capable of moving in a direction (X direction) crossing (perpendicularly in the present embodiment) the conveyance direction of the print medium M conveyed by the conveyance part 402 (Y direction). Further, the printing apparatus 10 includes a maintenance part 408 capable of executing a maintenance process for maintaining well or restoring the ink ejection performance at nozzles in the print head 404 which eject the inks.

The print head 404 is configured to be capable of ejecting multiple types of inks. Multiple sets of nozzles that eject respective inks are arrayed along a direction crossing the X direction to form nozzle arrays. In the present embodiment, the print head 404 is configured to be capable of ejecting four types of inks, namely, black (K), cyan (C), magenta (M), and yellow (Y) inks. Note that the types and number of inks to be ejected from the print head 404 are not limited to the above types and number.

The carriage 406 is slidably provided on a guide shaft 410 extending in the X direction and connected to a carriage motor 414 through a belt 412. In this way, the carriage 406 is capable of reciprocally moving in the X direction in response to being driven by the carriage motor 414. Thus, the print head 404 mounted on the carriage 406 is configured to be capable of reciprocally moving in the X direction with the carriage 406.

In a printing operation, driving pulses are applied to the print head 404 to thereby eject the inks from the print head 404 onto the print medium M while the carriage 406 is moved in the X direction, so that printing is performed for a single scan on a printing surface Mp of the print medium M. Note that the carriage 406 is provided with a detection part 416 capable of detecting the printing surface Mp of the print medium M. This enables the printing apparatus 10 to detect the printing surface Mp with the detection part 416 while moving the carriage 406 and thus monitor the result of printing on the printing surface Mp by the print head 404.

The conveyance part 402 includes a conveyance roller 418 that conveys the print medium M, and a conveyance motor 420 that drives the conveyance roller 418. Note that, in FIG. 4, the conveyance roller 418 and the print medium M are illustrated to be separated from each other in the Z direction in order to facilitate the understanding, but the print medium M and the conveyance roller 418 are actually in abutment with each other in the Z direction. The conveyance part 402 drives the conveyance motor 420 to convey the print medium M in the Y direction with the conveyance roller 418. In the present embodiment, the conveyance motor 420 functions as a driving motor that drives the conveyance roller.

In a case of performing printing on the print medium M based on a job, a printing operation is executed in which the inks are ejected from the print head 404 onto the print medium M conveyed to a print start position by the conveyance part 402 to perform printing for a single scan. Thereafter, a conveyance operation in which the print medium M is conveyed by a predetermined amount by the conveyance part 402 is performed, followed by a printing operation again. The printing apparatus 10 performs printing on the print medium M based on a job by alternately repeating a printing operation and a conveyance operation.

The maintenance part 408 is disposed inside the area in which the carriage 406 moves in the X direction but outside the area in which the print head 404 perform printing on the print medium M in the X direction. The maintenance part 408 includes a cap part 422 that abuts on (caps) the print head 404 in order to protect a nozzle surface 404a of the print head 404. Incidentally, though not described or illustrated in detail, the maintenance part 408 includes various publicly known maintenance members, such as a suction part that brings the inside of the cap part 422 to a negative pressure by suction and a wiper part that wipes the nozzle surface 404a, for example. The nozzle surface 404a is a surface of the print head 404 which faces the printing surface Mp of the print medium M conveyed and in which nozzles for ejecting the inks are formed.

In capping with the cap part 422, the print head 404 is moved to a position at which the nozzle surface 404a faces the cap part 422 of the maintenance part 408 (a waiting position to be described later) (see the dashed-line portion in FIG. 4), and then the cap part 422 is raised. In the present embodiment, the print head 404 waits at the waiting position, at which the nozzle surface 404a faces the cap part 422, at timings such as when no printing operation is performed. By performing capping after printing based on a job is finished, it is possible to protect the nozzle surface 404a and also prevent evaporation of the inks' liquid components from the nozzles and thickening of the inks inside the nozzles due to the evaporation.

Note that the ink ejection performance of the nozzles will still deteriorate even in a case where capping as above is performed. For this reason, the maintenance part 408 executes a maintenance process for maintaining the ejection performance well or recovering the ejection performance in response to an input from the user through the operation panel 208, for example. As the maintenance process, various publicly known processes are usable such as a suction process of forcibly sucking the ink from each nozzle by driving a suction part in a capped state and a wiping process of wiping the nozzle surface 404a with the wiper part, for example. Thus, the maintenance process is a process implemented by multiple operations involving driving, such as an operation of moving the print head 404 (carriage 406) to the waiting position, an operation of moving the cap part 422, a suction operation by the suction part, and an operation of moving the wiper part. In the present embodiment, the configuration is such that the maintenance part 408 includes the cap part 422, but is not limited to this. The cap part 422 may be provided as a separate part from a maintenance part including a suction part and a wiper part,

### <Information Processing Apparatuses>

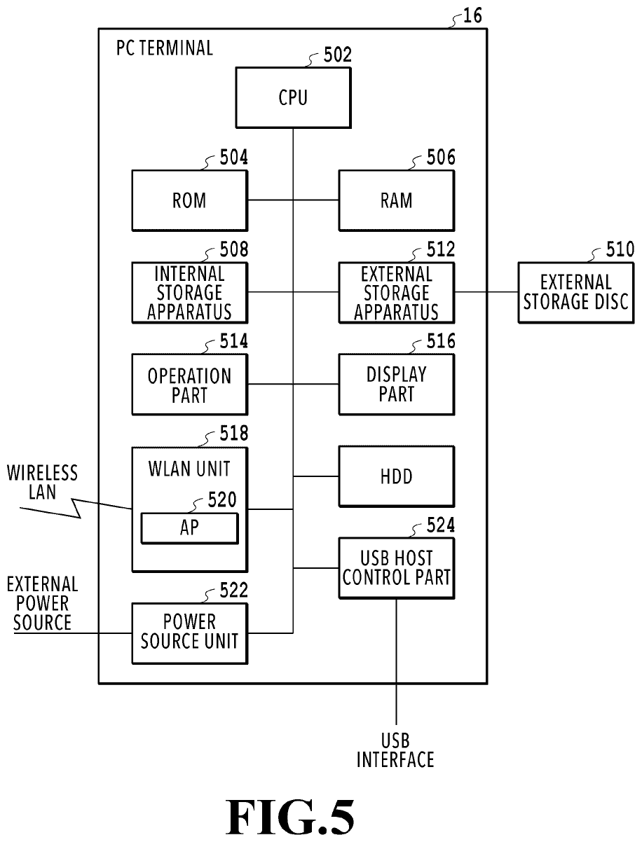

Next, a configuration of information processing apparatuses in the printing system 12 capable of processing pieces of information used in the printing apparatus 10, such as the PC terminal 16 and the smartphone 30, will be described. FIG. 5 is a schematic configuration diagram illustrating an example of the information processing apparatuses. Note that, in the description using FIG. 5, the PC terminal 16, which is connected to the printing apparatus 10 through the USB cable 28 and serves as a power supply source for the printing apparatus 10 in the printing system 12, will be described as an example of the information processing apparatuses.

The PC terminal 16 as an information processing apparatus includes a CPU 502 that controls the operation of the whole PC terminal 16 in accordance with various programs stored in a storage area to be described later or the like. The PC terminal 16 also includes a ROM 504 that stores a control program for the CPU 502 and the like, and a RAM 506 that temporarily stores various pieces of information and functions as a work area for the PC terminal 502. The PC terminal 16 further includes an internal storage apparatus 508 that stores various application programs such as an operating system and a wireless LAN setting application (described later), image data, and the like.

The PC terminal 16 includes an external storage apparatus 512 that obtains the pieces of application software stored in the internal storage apparatus 508 through an external storage disc 510 received from another computer-readable storage medium in which the pieces of application software are stored. Note that the external storage disk refers to a medium such as a compact disc (CD) or a digital versatile disc (DVD). The PC terminal 16 also includes an operation part 514 that accepts inputs from input devices (not illustrated), such as a keyboard and a mouse, and a display part 516 that is capable of displaying various pieces of information.

The PC terminal 16 includes a WLAN unit 518 for connecting to a wireless LAN. Note that the specific function of the WLAN unit 518 is the same as the wireless LAN unit 210. This WLAN unit 518 includes an AP 520 for connecting to the printing apparatus 10 and other external apparatuses (information processing apparatuses). Also, the PC terminal 16 includes a power source unit 522 that supplies power required for operations. The power source unit 522 is capable of storing electric power by being supplied with electric power from an external power source, such as an alternating current (AC) power source.

The PC terminal 16 has the function of a host in a USB connection, and includes a USB host control part 524 that connects to the printing apparatus 10 through the USB cable 28. In a case where a USB device is connected to the USB host control part 524 through a USB cable, the CPU 502 instructs the power source unit 522 to supply electric power to the USB host control part 524. As a result, the USB host control part 524 supplies electric power to the printing apparatus 10 through the USB cable 28. The electric power supplied to the printing apparatus 10 through the USB cable 28 is supplied to a power supply control circuit 236 through the USB interface 214.

The USB interface 214 is capable of supplying electric power and performing communication at the same time. Thus, the printing apparatus 10 is capable of receiving print data from the PC terminal 16 through the USB interface 214. Hence, in the present embodiment, the PC terminal 16 can cause the printing apparatus 10 to execute printing through the USB interface 214, and is capable of wirelessly causing the printing apparatus 10 to execute printing after connecting thereto in a communicable manner in any of the connection modes to be described later.

### <Communication Modes>

Next, types of communication modes that enable wireless communication between the printing apparatus and an information processing apparatus such as the PC terminal 16 or the smartphone 30 will be described.

The wireless LAN unit 210 connects to a terminal on a network (a network where connections complying with Transmission Control Protocol/Internet Protocol (TCP/IP) can be established) through a wireless LAN connection (wireless connection). Also, the wireless LAN unit 210 is a unit for establishing wireless LAN connections with the wireless LAN access point 18 and information processing apparatuses. The wireless LAN unit 210 is capable of establishing data (packet) connections in a wireless LAN system complying with the IEEE 802.11 series, for example.

By setting a communication mode for an information processing apparatus, the printing apparatus 10 is communicatively connected to the information processing apparatus through the wireless LAN unit 210 in a form of connection corresponding to the communication mode. That is, in the present embodiment, the printing apparatus 10 executes communication in a form of connection corresponding to a set communication mode through a wireless LAN. In the printing apparatus 10, communication modes such as a connection setting process mode, a Wi-Fi Direct (registered trademark) mode (hereinafter referred to as “WFD mode”), a software AP mode, an infrastructure mode, and an ad hoc mode can be set, for example.

Note that the configuration is not limited to one in which the printing apparatus 10 is exclusively set to one communication mode, and may be simultaneously set to multiple modes. For example, the printing apparatus 10 may operate in the software AP mode and the infrastructure mode at the same time or operate in the WFD mode and the infrastructure mode at the same time. Also, the communication modes are not limited only to the modes listed above, and various publicly known communication modes may be used. The above communication modes will now be described below.

### =Connection Setting Process Mode=

The connection setting process mode is a mode to be used in a case of setting the printing apparatus 10 to a communication mode. A process of setting the printing apparatus 10 to a communication mode is, in other words, a connection setting process for communicatively connecting the printing apparatus 10 and an external apparatus such as an information processing apparatus to each other. Note that the connection setting process will be described later. The printing apparatus 10 connects to an external apparatus in the form of connection corresponding to the communication mode set by the connection setting process.

In a case of operating in the connection setting process mode, the printing apparatus 10 performs an enabling process of enabling the AP 244 (see FIG. 2) provided in the wireless LAN unit 210 in accordance with software's settings. Note that the AP 244 is an AP that is enabled only during the connection setting process mode, and is an AP dedicated for the connection setting process mode. In a case where the AP 244 is enabled, the printing apparatus 10 transmits a beacon signal (packet) containing the service set identifier (SSID) of the AP 244 at regular intervals. In this way, an information processing apparatus capable of communicating with the printing apparatus 10 can detect the AP 244 by performing an AP search.

The SSID of the AP 244 is formed in a format following a preset rule. By recognizing this rule, the information processing apparatus identifies the AP 244, i.e., the printing apparatus 10. Also, by identifying the AP 244, the information processing apparatus performs peer-to-peer (hereinafter referred to as “P2P”) communication with the printing apparatus 10 through the AP 244. Note that the P2P communication refers to a form of communication in which the printing apparatus 10 and the information processing apparatus directly communicate with each other with no other external apparatus (e.g., the wireless LAN access point 18 or the like) interposed therebetween. As the rule for the SSID, for example, information identifying the model of the printing apparatus 10 or the series including the model, the media access control (MAC) address of the printing apparatus 10, its manufacturer, and the like are used. The SSID is stored in the program memory 218 in advance.

By being set in the connection setting process mode, the printing apparatus 10 can set itself to a communication mode suitable for the network environment around the printing apparatus 10. For example, the communication mode is set by executing a reception process of receiving setting information from the information processing apparatus. Examples of the setting information include the AP information to be described later, information on the communication mode to which the printing apparatus 10 is set, and the like. Processes utilizing the connection setting process mode can be executed without a cable. For this reason, the connection setting process mode is called “cableless setup mode”.

### =WFD Mode=

The WFD mode is a mode for establishing a wireless connection based on a WFD standard. In a case where the printing apparatus 10 operates in the WFD mode, the printing apparatus 10 establishes a direct wireless connection with an information processing apparatus by a P2P connection method. In this case, through which apparatus' AP to establish the connection is determined by Group Owner Negotiation. Note that the printing apparatus 10 in the WFD mode may connect to the information processing apparatus always through the AP provided to the printing apparatus 10 (not illustrated) without executing Group Owner Negotiation. In a case of setting the printing apparatus 10 to the WFD mode, the information processing apparatus transmits setting information representing the WFD mode to the printing apparatus 10 operating in the connection setting process mode.

### =Software AP Mode=

The software AP mode is a mode for directly establishing a P2P connection between the printing apparatus 10 and an information processing apparatus through the AP provided to the printing apparatus 10 (not illustrated). Note that the AP to be enabled in this case is different from the AP 244 to be enabled during the connection setting process mode, and the AP to be enabled during the WFD mode (not illustrated). Thus, the AP 244 to be enabled during the connection setting process mode, the AP to be enabled during the WFD mode (not illustrated), and the AP to be enabled during the software AP mode have different SSIDs and passwords. In a case of setting the printing apparatus 10 to the software AP mode, the information processing apparatus transmits setting information representing the software AP mode to the printing apparatus 10 operating in the connection setting process mode.

### =Infrastructure Mode=

The infrastructure mode is a connection method for communicatively connecting the printing apparatus 10 to an information processing apparatus through another external apparatus (e.g., the wireless LAN access point 18 or the like). That is, the infrastructure mode is a mode for wirelessly connecting the printing apparatus 10 and an information processing apparatus through the above external apparatus. Note that, in order for the printing apparatus 10 to operate in the infrastructure mode, the printing apparatus 10 needs to receive the SSID of the AP to be used in the infrastructure mode and AP information of this AP from the information processing apparatus or the like and register them in the printing apparatus 10 itself. Note that the AP information is a parameter for the printing apparatus 10 to utilize the AP.

### =Ad Hoc Mode=

The ad hoc mode is a mode for directly establishing a wireless connection between the printing apparatus 10 and an information processing apparatus. In the ad hoc mode, unlike the WFD mode and the software AP mode, a connection is established through neither of the APs in the apparatuses to be connected. In order to operate in the ad hoc mode, the printing apparatus 10 needs to receive a wireless connection parameter common to that of the information processing apparatus as setting information and register it in the printing apparatus 10.

### =Connection Setting Process=

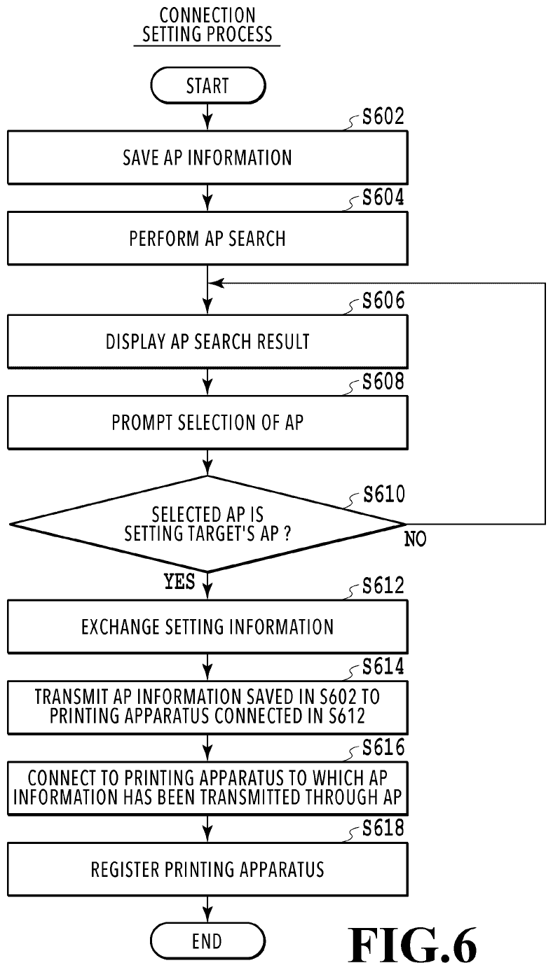

Next, the connection setting process as a process of setting the printing apparatus 10 to a communication mode will be described. The connection setting process is a process in which an information processing apparatus sets the printing apparatus 10 having launched the connection setting process mode to a communication mode. FIG. 6 is a flowchart illustrating details of processing in the connection setting process. The CPU 502 performs the series of processes illustrated in the flowchart of FIG. 6 by loading program code stored in the ROM 504 to the RAM 506 and executing it. Alternatively, the functions of some or all of the steps in FIG. 6 may be implemented with hardware such as an ASIC or an electric circuit. The sign “S” in the description of each process in a flowchart herein means a step in that flowchart.

The connection setting process is started in a case where the wireless LAN setting application is launched in response to the user's operation on the operation part 514. This connection setting process is executed at a timing such as when an initial setup to be initially performed after the installation of the printing apparatus 10 is performed, when the wireless LAN setting of the printing apparatus 10 is disabled, or after an initialization process of the printing apparatus 10, for example. Note that the wireless LAN setting application is an application for setting the printing apparatus 10 to a communication mode. Also, the wireless LAN setting application may have other functions such as a function of transmitting a job to the printing apparatus 10 to cause it to execute printing. Further, the wireless LAN setting application is a program stored in the internal storage apparatus 508, and the user installs it in the information processing apparatus (the PC terminal 16 in the present embodiment) in advance.

In the following description, a case where the AP to be used in the infrastructure mode is registered in the printing apparatus 10 by the wireless LAN setting application to set the printing apparatus 10 to the infrastructure mode will be described as an example. The AP may be registered by utilizing a service on the Internet through a web browser, other functions of the information processing apparatus and the printing apparatus 10, instead of utilizing the wireless LAN setting application.

Upon start of the connection setting process, first, in S602, the CPU 502 temporarily saves the AP information of the AP to which the PC terminal 16, which is an information processing apparatus, is connected in the RAM 506. Then, in S604, the CPU 502 searches for APs which the PC terminal 16 can access through the WLAN unit 518. The AP search may be executed automatically at the launch of the wireless LAN setting application or executed in response to the user's instruction. Also, the AP search is executed by receiving beacons transmitted by APs with the WLAN unit 518.

Then, in S606, the CPU 502 displays the APs found in the search in S604 (AP search result) in the form of a list on the display part 516. Here, as the AP search result, the SSIDs of the APs are displayed in the form of a list, for example. Note that, in S606, APs having SSIDs in a format following the rule for the SSID of the AP 244 may be automatically extracted and displayed. Incidentally, in a case where there are multiple SSIDs in a format following the rule, those multiple SSIDs will be displayed, and the user will be prompted to select one from among them. Also, S610 to be described later may be omitted in a case of employing a configuration as above.

After the AP search result is displayed on the display part 516, the CPU 502 proceeds to S608 and prompts selection of the AP of the printing apparatus 10 to be set to a communication mode (setting target) from the AP search result. In a case where the AP of the printing apparatus 10 is selected from the AP search result, the CPU 502 proceeds to S610 and determines whether the selected AP is the AP of the printing apparatus 10 being the setting target for the wireless LAN setting application. Specifically, in S610, the CPU 502 determines whether the selected AP is an AP having an SSID in a format following the rule for the SSID of the AP 244. If the selected AP is an AP having an SSID in a format following the rule for the SSID of the AP 244, the CPU 502 determines that the selected AP is the AP of the printing apparatus 10 being the setting target. If the selected AP is not an AP having an SSID in a format following the rule for the SSID of the AP 244, the CPU 502 determines that the selected AP is the AP of the printing apparatus 10 being the setting target.

If determining in S610 that the selected AP is not the AP of the setting-target printing apparatus, the CPU 502 returns to S606. In this case, the CPU 502 may display a notification indicating that the selected AP is not the AP of the setting-target printing apparatus on the display part 516. Also, in response to the notification to the user and the selection by the user, the CPU 502 may terminate this connection setting process in a case where it can be determined that there is no AP corresponding to the setting-target printing apparatus or the AP of a printing apparatus desired by the user is not present or in another similar case.

Also, if determining in S610 that the selected AP is the AP of the setting-target printing apparatus, the CPU 502 proceeds to S612 and exchanges a parameter for the PC terminal 16 and the printing apparatus 10 having the selected AP to be wirelessly connected to each other (connection information) with the printing apparatus 10. The connection information for connecting to the AP 244 has been held in the wireless LAN setting application in advance. As a result, the PC terminal 16 connects to the AP 244 in the printing apparatus 10, which has launched the connection setting process mode, and establishes communication with the printing apparatus 10.

Then, in S614, the CPU 502 transmits the AP information temporarily saved in the RAM 506 in S602 as setting information to the printing apparatus 10 through the AP 244, to which the PC terminal 16 has connected by exchanging the connection information in S612. By receiving the AP information from the PC terminal 16, the printing apparatus 10 is set to the infrastructure mode in which a connection can be established through the AP based on this AP information. Then, in S616, the CPU 502 disconnects from the AP 244 and connects to the AP based on the AP information saved in the RAM 506 in S602 to thereby be in a state where the PC terminal 16 can communicate with the printing apparatus 10 through that AP. Thereafter, in S618, the CPU 502 registers the printing apparatus 10 in the RAM 506 as the target for the PC terminal 16 to communicatively connect to from now, and then terminates the wireless LAN setting application to thereby terminate this connection setting process.

In this connection setting process, the processes of S606 to S610 involve the user to select the AP of the printing apparatus 10 to be set to a communication mode, but the connection setting process is not limited to this. For example, the CPU 502 may select an AP having an SSID in a format following the rule for the SSID of the AP 244 from among the APs found in S604.

The processes of S604 to S608 may be omitted, and an application other than the wireless LAN setting application that is installed in the PC terminal 16 or the like may search for the AP 244, and the wireless LAN setting application may obtain the result of the search.

The PC terminal 16 (CPU 502) communicates with the printing apparatus 10 through the AP 244, the PC terminal 16 transmits the setting information to the printing apparatus 10 by a communication method complying with the IEEE 802.11 series (i.e., Wi-Fi (registered trademark)). However, the communication method for transmitting the setting information is not limited to this, and the PC terminal 16 may transmit the setting information to the printing apparatus 10 by a communication method different from the communication method complying with the IEEE 802.11 series, for example. Examples of employable communication methods include Bluetooth (registered trademark) Classic, Bluetooth Low Energy, Near Field Communication, Wi-Fi Aware, and the like. Using such a communication method enables the CPU 502 to transmit the setting information to the printing apparatus 10 while maintaining a Wi-Fi connection with the AP used in the infrastructure mode.

In the connection setting process described above, a case of setting the communication mode between the PC terminal 16 and the printing apparatus 10 to the infrastructure mode has been described, but the WFD mode, the software AP mode, or the like can also be set in the connection setting process. A publicly known technology can be used to set such a communication mode, and detailed description thereof is therefore omitted.

The communication mode to which the printing apparatus 10 is to be set may be determined by having the user select it on a screen displayed by the wireless LAN setting application, or determined by the wireless LAN setting application based on the communication environment of the PC terminal 16, for example. Suppose a configuration in which the wireless LAN setting application makes the determination. In this case, when the printing apparatus 10 is set to a communication mode, the infrastructure mode is selected as the communication mode to which the printing apparatus 10 is to be set if the PC terminal 16 is connected to an AP, for example. Also, when the printing apparatus 10 is set to a communication mode, a P2P communication mode such as the WFD mode or the software AP mode is selected as the communication mode to which the printing apparatus 10 is to be set if the PC terminal 16 is connected to no AP, for example.

### <Switching Process>

In the printing system 12 with the above configuration, the connection setting process is executed in response to launching the wireless LAN setting application in the PC terminal 16 at a predetermined timing such as the installation of the printing apparatus 10. During the connection setting process, the printing apparatus 10 needs to supply electric power to the wireless LAN unit 210 in order to be able to establish a wireless connection with the PC terminal 16. Also, during the connection setting process, a timeout time is set in consideration of the user's operation time and the like. In a case where 1 hour is set as the timeout time, for example, the wireless LAN unit 210 will continue consuming electric power for that period. Further, even after a connection is established between the PC terminal 16 and the printing apparatus 10, the wireless LAN unit 210 will still continue consuming electric power in order to maintain the connection. The printing apparatus 10 launches the connection setting process mode, so that electric power will be supplied to the wireless LAN unit 210 during and after the connection setting process.

Also, the printing apparatus 10 needs to execute the maintenance process for maintaining well or restoring the ink ejection performance of the print head 404 at the installation and at regular timings. Generally, executing such a maintenance process involves moving the print head 404, executing a suction process and a wiping process with the maintenance part 408, and the like. Thus, driving constituent members of the maintenance part 408 and the like consume a large volume of electric power. Thus, depending on the amount of electric power supplied from the PC terminal 16 through the USB cable 28, the electric power stored in the EDLC 302 may need to be used along with it. In this case, if the amount of electric power stored in the EDLC 302 falls to or below a certain value, the EDLC 302 is charged, so that the process of consuming electric power stops until the stored amount of electric power reaches a predetermined amount or more. There is also a risk that the electric power stored in the EDLC 302 is used up and a system shutdown occurs due to an abrupt voltage drop.

Hence, in a case of using only the electric power supplied from the PC terminal 16 to launch the connection setting process mode and execute the maintenance process, the amount of this electric power must be a recommended amount of current with which the stoppage of the process or the system shutdown will not occur. As long as an ability to supply, for example, 1.5 A (7.5 W) or more as the electric power to be supplied from the PC terminal 16 through the USB cable 28 is secured, it is possible to design the capacity of the EDLC 302, the amount of electric power to be consumed in the process, and the peak current such that the process can be continued while the EDLC 302 is charged. Also, for example, with an electric power of 900 mA (4.5 W) or more and 1.5 A (7.5 W) or less with USB 3.0, it is possible to design the capacity of the EDLC 302, the amount of electric power to be consumed in the process, and the peak current such that the maintenance process and launching of the connection setting process mode can be executed separately.

However, depending on the specifications of the USB host (an electric power supply source, which is the PC terminal 16 in the present embodiment), the specifications of the USB cable, and the like, it may be impossible to supply the recommended amount of current to the printing apparatus 10. For example, while there are PC terminals, chargers, and the like supporting USB charging standards such as Battery Charging Specification and capable of high power supply such as USB Power Delivery, USB 3.0 can supply an amount of 900 mA. There are countries where USB hosts capable of high power supply as mentioned above have not been widely used. Also, some USB hosts provided at places where people go and public facilities do not support high power supply, for example. Even in a situation where the recommended amount of current cannot be supplied to the printing apparatus 10, it is necessary to ensure the execution of minimum operations even if the process takes time or the executable operations are limited.

For printing apparatuses that operate with electric power supplied through a USB cable, no technology has been proposed for executing a process that is implemented by multiple operations involving driving, such as the maintenance process, and a process that does not involve driving, such as a process related to setting a communication mode, according to the electric power supplied. Thus, there is a possibility that a process related to setting a communication mode and the maintenance process may be stopped while being executed and/or the printing apparatus 10 may experience a system shutdown depending on the electric power supplied to the printing apparatus 10. Incidentally, a process related to setting a communication mode is a process that is executed after the connection setting process mode is launched, and is a process for wirelessly connecting to an external apparatus such as the PC terminal 16. Specific examples thereof include a process of supplying electric power to the wireless LAN unit 210, a process of exchanging data with the PC terminal 16, and various setting processes corresponding to communication modes each of which can be set by the connection setting process. Also, “involving driving” means “using a driving force from a driving source transmitted through a mechanical mechanism”.

Thus, in the present embodiment, the printing apparatus 10 executes a switching process of switching the manner of executing the maintenance process and a process related to setting a communication mode according to the electric power supplied through a USB cable. The connection setting process is executed at a timing such as when an initial setup to be initially performed after the installation of the printing apparatus 10 is performed, when the wireless LAN setting of the printing apparatus 10 is disabled, or after an initialization process of the printing apparatus 10, as described above. Also, the maintenance process is executed after the attachment of ink tanks, the mounting of the print head 404, and the like following the installation of the printing apparatus 10 and at regular timings.

The switching process is executed at a timing at which the connection setting process and the maintenance process need to be executed, e.g., at an initial setup. Specifically, the switching process is started in a case where the USB cable 28 is connected to the PC terminal 16, which serves as a power supply source, and a start button in the operation panel 208 of the printing apparatus 10 is pressed at the installation of the printing apparatus 10. Note that the switching process may be executed at a timing such as when the printing apparatus 10 is re-set to a communication mode and a regular maintenance process is to be executed soon. That is, the switching process is executed in a case where a timing to execute the connection setting process and that for the maintenance process coincide with each other.

### =Details of Processing=

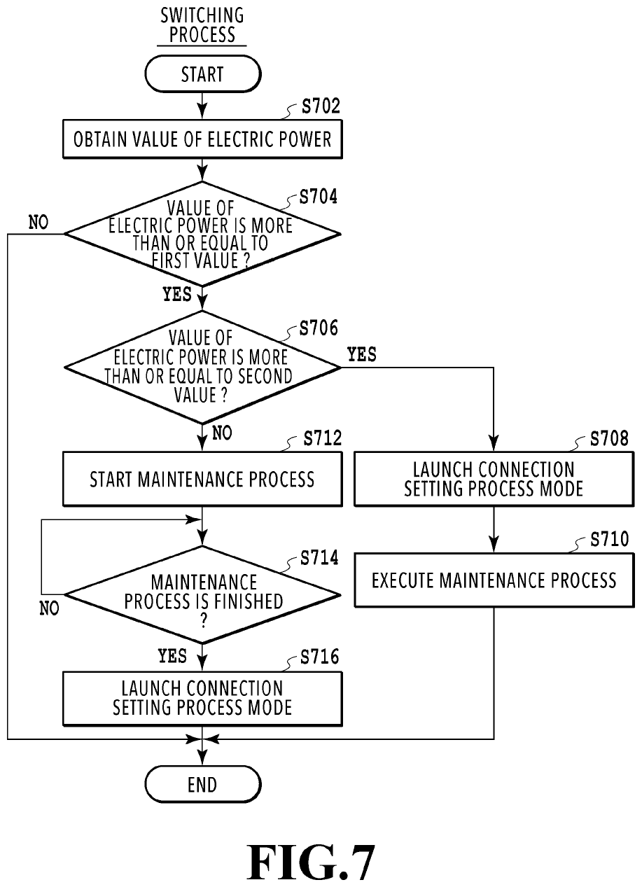

Next, details of processing in the switching process will be described in detail. FIG. 7 is a flowchart illustrating details of processing in the switching process. The CPU 216 performs the series of processes illustrated in the flowchart of FIG. 7 by loading program code stored in the program memory 218 to the data memory 220 and executing it. Alternatively, the functions of some or all of the steps in FIG. 7 may be implemented with hardware such as an ASIC or an electric circuit.

Upon start of the switching process, first, in S702, the CPU 216 obtains the value of electric power supplied through the USB interface 214 to which the USB cable 28 is connected. Once the printing apparatus 10 is booted, the ASIC 314 performs an enumeration process with the PC terminal 16 connected to the USB interface 214 through the USB cable 28. Then, based on the result of the enumeration process, the ASIC 314 outputs an instruction to control changing of the charging current of the EDLC 302 to the charger 304. The charger 304 makes determinations based on a USB-BC standard and a USB-PD standard. Thus, the value of electric power supplied through the USB interface 214 can be derived with the charger 304 or the ASIC 314. Accordingly, in S702, the CPU 216 obtains the value of electric power supplied through the USB interface 214 that is obtained by the charger 304 or the ASIC 314. Note that the configuration may be such that the value of electric power supplied through the USB interface 214 can be obtained only from the charger 304. In the present embodiment, the CPU 216 functions as an obtaining part that obtains the value of electric power supplied from the USB interface 214 through a USB cable. Note that this obtaining part may include the charger 304 and the ASIC 314.

Then, in S704, the CPU 216 determines whether or not the value of electric power obtained in S702 is more than or equal to a first value. The first value is a value of electric power with which the connection setting process mode and the maintenance process can be separately executed, and is 4.5 W (900 mA) in the present embodiment, for example. If determining in S704 that the value of electric power obtained in S702 is not more than or equal to the first value, the CPU 216 terminates this switching process. In this case, the CPU 216 may notify the user that the connection setting process mode and the maintenance process cannot be executed due to the supplied electric power being insufficient with the operation panel 208 or the like, for example. In a specific notification method, the CPU 216 displays information indicating that the connection setting process mode and the maintenance process cannot be executed due to the supplied electric power being insufficient on the display part 240 or announcing the information with a speaker (not illustrated).

If determining in S704 that the value of electric power obtained in S702 is more than or equal to the first value, the CPU 216 proceeds to S706 and determines whether or not the value of electric power obtained in S702 is more than or equal to a second value. The second value is a value of electric power with which the connection setting process mode and the maintenance process can be simultaneously executed, and is 7.5 W (1.5 A) in the present embodiment, for example. If determining in S706 that the value of electric power obtained in S702 is more than or equal to the second value, the CPU 216 proceeds to S708.

In S708, the CPU 216 launches the connection setting process mode for the connection setting process to be executed by the PC terminal 16. In the connection setting process mode, the printing apparatus 10 is in a state where an electric power supply process of supplying electric power to the wireless LAN unit 210 is executed, and data exchange with the PC terminal 16 and a setting process corresponding to the communication mode set by the connection setting process can be performed. Also, in S708, the CPU 216 starts counting time upon launching the connection setting process mode. The count value obtained by the counting will be used to determine a timeout time. The user can operate the PC terminal 16 to perform the connection setting process and set the communication mode for the printing apparatus 10 and the PC terminal at any time within the timeout time after the launch of the connection setting process mode in S708. Note that the connection setting process mode launched in S708 will be terminated as appropriate according to the timeout time, the communication mode with the PC terminal 16, and/or the like.

Then, in S710, the CPU 216 executes the maintenance process, and terminates this switching process once the maintenance process is finished. Specifically, if it is determined in S706 that the value of electric power obtained in S702 is more than or equal to the second value, it is determined that the process to be executed in the connection setting process mode and the maintenance process can be simultaneously executed. Thus, it is possible to execute the maintenance process, which involves physical operations and takes time, while executing the process to be executed in the connection setting process mode. Note that the connection setting process mode launched in S710 will be terminated as appropriate according to the timeout time, the communication mode with the PC terminal 16, and/or the like.

In S710, the CPU 216 checks whether preparations in the printing apparatus 10 necessary for executing the maintenance process, such as attaching the ink tanks (not illustrated) storing the inks to be ejected from the print head 404 and mounting the print head 404, have been done at this point. If these preparations have not been done yet, the CPU 216 prompts the user to execute the preparations. The CPU 216 executes the maintenance process after confirming that the preparations have been done.

Various publicly known technologies are usable for the maintenance process executed in S710. For example, in the maintenance process, first, the print head 404 is moved to the waiting position, and capping is performed on the print head 404 with the cap part 422. Then, the suction part (not illustrated) is driven to generate a negative pressure inside the cap part 422 and thereby suck the ink from each nozzle in the print head 404. Thereafter, the capping is released, and the inks and the like attached to the nozzle surface 404a are wiped off with wiper part (not illustrated). Incidentally, in the maintenance process to be executed at an initial setup, the inks need to be filled in channels extending from the ink tanks to the print head 404. Thus, the suction force and suction amount are set larger than those in the maintenance processes at other timings, for example, to make it easier for the inks to be filled into the above channels. Note that, in the maintenance process executed in the present embodiment, the peak value of electric power to be consumed as a whole may be reduced according to the electric power to be consumed by each of the multiple operations involving driving, its peak value, and the like, for example.

If determining in S706 that the value of electric power obtained in S702 is not more than or equal to the second value (less than a threshold value), the CPU 216 proceeds to S712 and starts the maintenance process. The maintenance process in S712 is the same as the maintenance process in S710. Thereafter, in S714, the CPU 216 determines whether the maintenance process is finished. If determining in S714 that the maintenance process is not finished, the CPU 216 performs the determination in S714 again. If determining in S714 that the maintenance process is finished, the CPU 216 proceeds to S716 and launches the connection setting process mode, and then terminates this switching process. The user can operate the PC terminal 16 to execute the connection setting process and set the communication mode for the printing apparatus 10 and the PC terminal 16 at any time within the timeout time after the launch of the connection setting process mode in S716. The connection setting process mode launched in S716 will be ended as appropriate according to the timeout time, the communication mode with the PC terminal 16, and/or the like.

If it is determined in S706 that the value of electric power obtained in S702 is not more than or equal to the second value, it is determined that the process to be executed in the connection setting process mode and the maintenance process cannot be simultaneously executed. Assume that the process to be executed in the connection setting process mode and the maintenance process are simultaneously executed in this state. Then, the electric power becomes insufficient with the output voltage V_{BUS} from the USB interface 214. Hence, the charger 304 determines that the maintenance process cannot be executed. As a result, the output voltage V_{BAT} from the EDLC 302 is used. Here, since the process to be executed in the connection setting process mode and the maintenance process are simultaneously executed, the electric power in the EDLC 302 is consumed in a short time. Then, as the amount of electric power stored in the EDLC 302 falls to or below a certain amount, the maintenance process is stopped, the EDLC 302 is charged until the amount of electric power stored therein reaches a predetermined value or more, and then the maintenance process is resumed.

Hence, the maintenance process in this case involves stopping the maintenance process, charging the EDLC 302, and resuming the maintenance process, and therefore takes time. Thus, in the present embodiment, if it is determined the value of electric power obtained in S702 is not more than or equal to the second value, the maintenance process is finished before launching the connection setting process mode which involves an operation for a relatively long time after being launched. In this way, even in a case where the electric power in the EDLC 302 is used, the number of times to charge the EDLC 302 will be smaller. This makes it possible to efficiently execute the maintenance process. As described above, in the present embodiment, the second value serves as a threshold value for switching the manner of executing the process to be executed in the connection setting process mode and the maintenance process. Also, in the present embodiment, the CPU 216 functions as a control unit that controls the execution of the process to be executed in the connection setting process mode and the maintenance process.

### Advantageous Effects

As described above, the printing apparatus 10 performs the switching process at a timing at which the connection setting process and the maintenance process need to be executed. In this switching process, in a case where the value of electric power supplied through a USB cable is more than or equal to the first value and less than the second value, the connection setting process mode is launched after the maintenance process is finished. This reduces the number of times to charge the EDLC 302 and makes it possible to efficiently execute the maintenance process. Also, in a case where it is determined that the value of electric power supplied through the USB cable is more than or equal to the second value (more than or equal to a threshold value), the maintenance process is executed after the connection setting process mode is launched. This makes it possible to simultaneously execute the process to be executed in the connection setting process mode and the maintenance process. Accordingly, it is possible execute the connection setting process during the maintenance process and efficiently execute these two processes.

### Second Embodiment

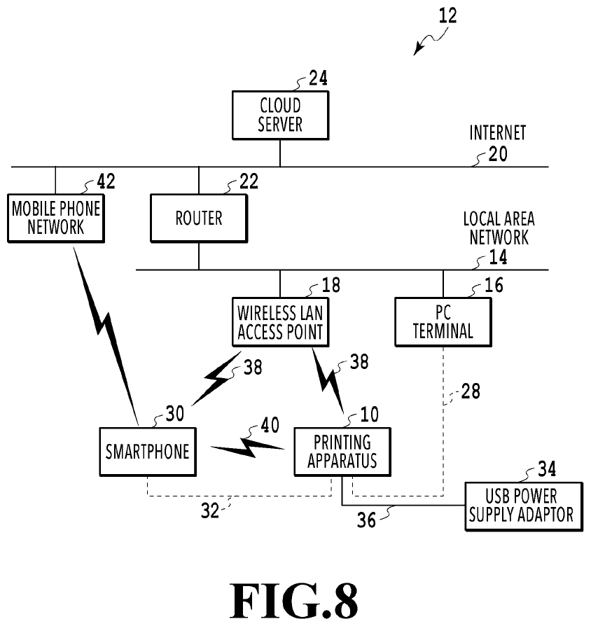

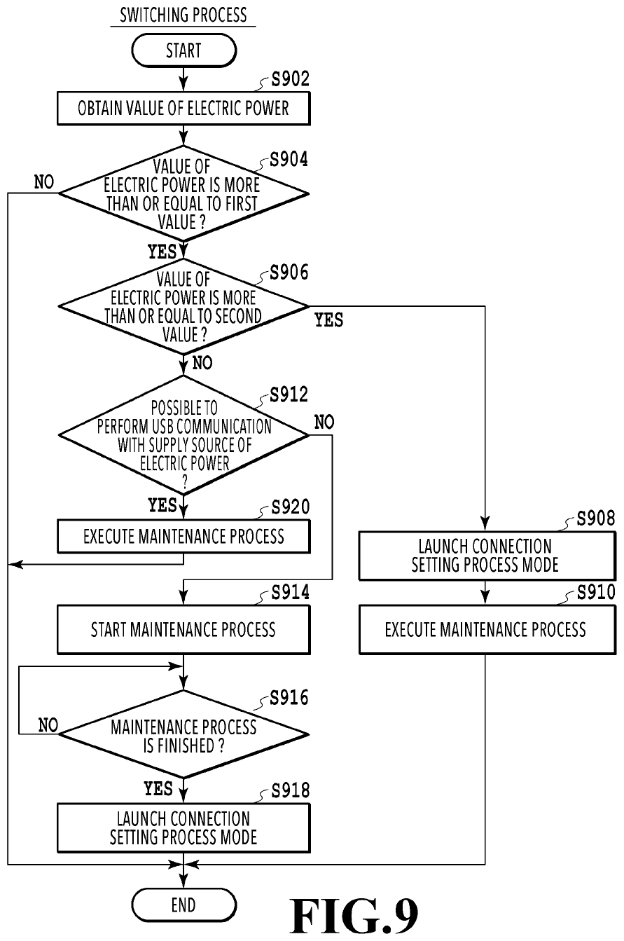

Next, a printing apparatus according to a second embodiment will be described with reference to FIGS. 8 and 9. In the following description, for identical or corresponding components to those in the printing apparatus according to the first embodiment, specific description thereof will be omitted by using the identical reference signs to those used in the first embodiment.

The second embodiment differs from the above first embodiment in that the connection setting process mode is launched depending on whether data communication through a USB cable is possible in a case where the value of electric power supplied through the USB cable is more than or equal to a first value and less than a second value.

### <Printing System>

The printing system 12 including the printing apparatus 10 according to the second embodiment is configured as illustrated in FIG. 8. FIG. 8 is a schematic configuration diagram of the printing system 12 including the printing apparatus according to the second embodiment. Specifically, in the printing system 12 according to the present embodiment, the printing apparatus 10 is not connected to the PC terminal 16 through the USB cable 28, and is connected to the USB power supply adaptor 34 through the USB cable 36. Thus, the USB interface 214 of the printing apparatus 10 is exclusively for supplying electric power, and data exchange between the printing apparatus 10 and information processing apparatuses such as the PC terminal 16 and the smartphone 30 is executed through an wireless apparatus. With such a configuration, the printing apparatus 10 and the PC terminal 16 need to be wirelessly connected to each other. Making a wireless connection easily establishable in the connection setting process will improve user friendliness.

### <Switching Process>

Next, a switching process executed by the printing apparatus 10 according to the second embodiment will be described. FIG. 9 is a flowchart illustrating details of processing in the switching process executed by the printing apparatus 10 according to the second embodiment. The CPU 216 performs the series of processes illustrated in the flowchart of FIG. 9 by loading program code stored in the program memory 218 to the data memory 220 and executing it. Alternatively, the functions of some or all of the steps in FIG. 9 may be implemented with hardware such as an ASIC or an electric circuit.

In the printing apparatus 10 according to the second embodiment, upon start of the switching process, first, in S902, the CPU 216 obtains the value of electric power supplied through the USB interface 214 to which the USB cable 28 is connected. Then, in S904, the CPU 216 determines whether or not the value of electric power obtained in S902 is more than or equal to the first value. If determining in S904 that the value of electric power obtained in S902 is not more than or equal to the first value, the CPU 216 terminates this switching process. If determining in S904 that the value of electric power obtained in S902 is more than or equal to the first value, the CPU 216 proceeds to S906 and determines whether or not the value of electric power obtained in S902 is more than or equal to the second value.

If determining in S906 that the value of electric power obtained in S902 is more than or equal to the second value, the CPU 216 proceeds to S908 and launches the connection setting process mode. Then, in S910, the CPU 216 executes the maintenance process, and terminates this switching process. The details of processing in S902 to S910 are the same as S702 to S710 described above, and specific description thereof is therefore omitted.

If determining in S906 that the value of electric power obtained in S902 is not more than or equal to the second value, the CPU 216 proceeds to S912 and determines whether it is possible to communicate with the supply source of the electric power supplied from the USB interface 214 through the connected USB cable. In S912, the CPU 216 causes the charger 304 or the ASIC 314 to determine whether it is possible to communicate with the supply source of the electric power supplied from the USB interface 214 through the connected USB cable. The ASIC 314 uses an enumeration process to determine whether it is possible to communicate with the supply source of the electric power supplied from the USB interface 214 through the connected USB cable. Alternatively, the ASIC 314 may determine whether bulk-in and bulk-out transfers or interrupt transfers complying with a USB standard were actually successfully performed with the supply source.

If determining in S912 that it is not possible to communicate with the supply source of the electric power supplied from the USB interface 214 through the connected USB cable, the CPU 216 proceeds to S914. If it is determined in S912 that it is not possible to communicate with the supply source of the electric power supplied from the USB interface 214 through the connected USB cable, the printing apparatus 10 cannot exchange data with the PC terminal 16 without a wireless apparatus interposed therebetween. For this reason, the printing apparatus 10 and the PC terminal 16 need to be wirelessly connected to each other.

Thus, in S914, the CPU 216 starts the maintenance process. Then, in S916, the CPU 216 determines whether the maintenance process is finished, and performs the determination in S916 again if determining that the maintenance process is not finished. If determining in S916 that the maintenance process is finished, the CPU 216 proceeds to S918 and launches the connection setting process mode, and then terminates this switching process. The details of processing in S914 to S918 are the same as S712 to S716 described above, and specific description thereof is therefore omitted.

If determining in S912 that it is possible to communicate with the supply source of the electric power supplied from the USB interface 214 through the connected USB cable, the CPU 216 proceeds to S920. If it is determined in S912 that it is possible to communicate with the supply source of the electric power supplied from the USB interface 214 through the connected USB cable, the printing apparatus 10 can exchange data with the PC terminal 16 through the USB cable. Thus, the necessity for a wireless connection between the printing apparatus 10 and the PC terminal 16 is low.

Thus, in S920, the CPU 216 executes the maintenance process, and terminates this switching process once the maintenance process is finished. In sum, if it is determined in S912 that it is possible to communicate with the supply source of the electric power supplied from the USB interface 214 through the connected USB cable, the connection setting process mode will not be launched.

### Advantageous Effects

As described above, in the present embodiment, the switching process is performed at a timing at which the connection setting process and the maintenance process need to be executed. In this switching process, in a case where the value of electric power supplied through a USB cable is more than or equal to the first value and less than the second value, and it is not possible to communicate with the supply source of the electric power through the USB cable, the connection setting process mode is launched after the maintenance process is finished. Also, in a case where the value of electric power supplied through the USB cable is more than or equal to the first value and less than the second value, and it is possible to communicate with the supply source of the electric power through the USB cable, the maintenance process is executed without launching the connection setting process mode. Further, in a case where it is determined that the value of electric power supplied through the USB cable is more than or equal to the second value, the maintenance process is executed after the connection setting process mode is launched. This makes it possible to simultaneously execute the process to be executed in the connection setting process mode and the maintenance process. In this way, in the present embodiment, in addition to the advantageous effects of the first embodiment described above, it is possible to efficiently execute the process to be executed in the connection setting process mode according to whether it is possible to communicate with the supply source of the electric power through the USB cable.

### Third Embodiment

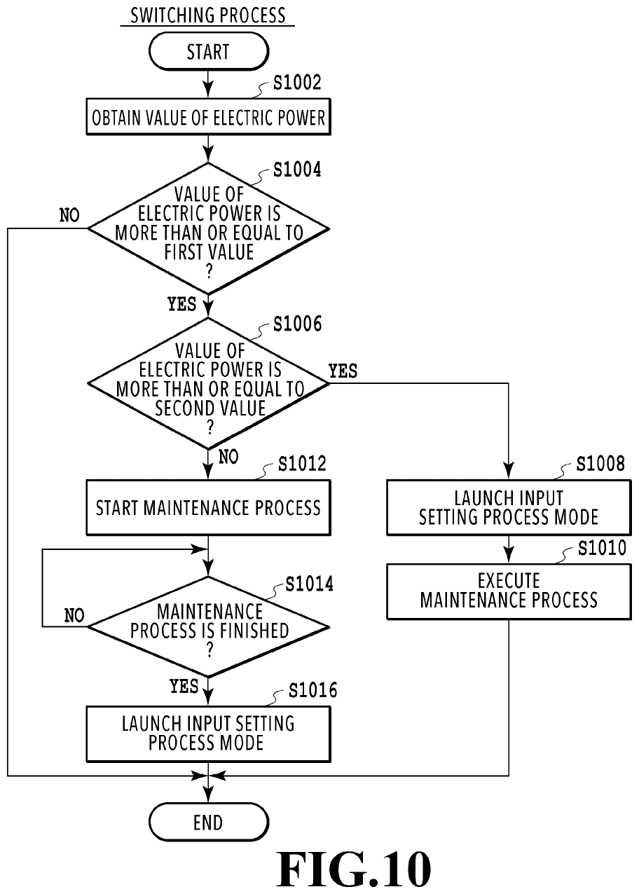

Next, a printing apparatus according to a third embodiment will be described with reference to FIG. 10. In the following description, for identical or corresponding components to those in the printing apparatus according to the first embodiment, specific description thereof will be omitted by using the identical reference signs to those used in the first embodiment.

The third embodiment differs from the above first embodiment in that an input setting process mode for configuring a setting with an input by utilizing displays on the display part 240 and the touch panel 242 of the operation panel 208 is launched instead of the connection setting process mode. The input setting process mode refers to a mode in which a setting can be configured based on the user's input. In a process executed with the input setting process mode launched, the CPU 216 displays a screen necessary for configuring a setting with an input on the display part 240 and the touch panel 242, and configures the setting in accordance with an input that is based on the user's operation on the operation panel 208. Examples of the setting to be configured in the input setting process mode includes the language setting, the printing setting, the time setting, and the like in the printing apparatus 10. A switching process executed by the printing apparatus 10 according to the third embodiment will now be described in detail below.

### <Switching Process>

FIG. 10 is a flowchart illustrating details of processing in the switching process executed by the printing apparatus 10 according to the third embodiment. The CPU 216 performs the series of processes illustrated in the flowchart of FIG. 10 by loading program code stored in the program memory 218 to the data memory 220 and executing it. Alternatively, the functions of some or all of the steps in FIG. 10 may be implemented with hardware such as an ASIC or an electric circuit.

In the printing apparatus according to the third embodiment, upon start of the switching process, first, in S1002, the CPU 216 obtains the value of electric power supplied through the USB interface 214 to which a USB cable is connected. Then, in S1004, the CPU 216 determines whether or not the value of electric power obtained in S1002 is more than or equal to a first value. If determining in S1004 that the value of electric power obtained in S1002 is not more than or equal to the first value, the CPU 216 terminates this switching process. If determining in S1004 that the value of electric power obtained in S1002 is more than or equal to the first value, the CPU 216 proceeds to S1006 and determines whether or not the value of electric power obtained in S1002 is more than or equal to a second value. The details of processing in S1002 to S1006 are the same as S702 to S706 described above.

If determining in S1006 that the value of electric power obtained in S1002 is more than or equal to the second value, the CPU 216 proceeds to S1008 and launches the input setting process mode. Once the input setting process mode is launched, a process related to configuring a setting based on an input is executed as a process not involving driving. In the process related to configuring a setting based on an input, a display process of displaying an input screen for configuring the setting with an input on the display part 240 and the touch panel 242, and a setting process of determining the setting based on the user's input on the input screen are executed as processes for configuring the setting based on an input. In the following, the above display process and the setting process will be referred to as “the processes to be executed in the input setting process mode”. Note that the display process is continuously executed, for example, until an input is obtained from the user. In the display process, the user may be prompted to configure the setting on the input screen, for example. Also, in the setting process, the setting based on the user's input is saved in the data memory 220 or the non-volatile memory 222.

Then, in S1010, the CPU 216 executes the maintenance process, and terminates this switching process once the maintenance process is finished. The details of processing in S1010 are the same as S710. Specifically, if it is determined in S1006 that the value of electric power obtained in S1002 is more than or equal to the second value, it is determined that the processes to be executed in the input setting process mode and the maintenance process can be simultaneously executed. Thus, it is possible to execute the maintenance process, which involves physical operations and takes time, while executing the processes to be executed in the input setting process mode. Note that the input setting process mode is kept launched even after the switching process is terminated. The input setting process mode launched in S1010 will be terminated as appropriate according to the user's input, the setting status, or the like.

If determining in S1006 that the value of electric power obtained in S1002 is not more than or equal to the second value, the CPU 216 proceeds to S1012 and starts the maintenance process. Thereafter, in S1014, the CPU 216 determines whether the maintenance process is finished. The details of processing in S1012 and S1014 are the same as S712 and S714 described above. If determining in S1014 that the maintenance process is finished, the CPU 216 proceeds to S1016 and launches the input setting process mode, and then terminates this switching process. The input setting process mode launched in S1016 will be terminated as appropriate according to the user's input, the setting status, or the like.

If it is determined in S1006 that the value of electric power obtained in S1002 is not more than or equal to the second value, it is determined that the processes to be executed in the input setting process mode and the maintenance process cannot be simultaneously executed. Assume that the processes to be executed in the input setting process mode and the maintenance process are simultaneously executed in this state. Then, the electric power becomes insufficient with the output voltage V_{BUS} from the USB interface 214. Hence, the charger 304 determines that the maintenance process cannot be executed. As a result, the output voltage V_{BAT} from the EDLC 302 is used. Here, since the processes to be executed in the input setting process mode and the maintenance process are simultaneously executed, the electric power in the EDLC 302 is consumed in a short time. Then, as the amount of electric power stored in the EDLC 302 falls to or below a certain amount, the maintenance process is stopped, the EDLC 302 is charged until the amount of electric power stored therein reaches a predetermined value or more, and then the maintenance process is resumed.

Hence, the maintenance process in this case involves stopping the maintenance process, charging the EDLC 302, and resuming the maintenance process, and therefore takes time. Thus, in the present embodiment, if it is determined the value of electric power obtained in S1002 is not more than or equal to the second value, the maintenance process is finished before launching the input setting process mode which involves operations for a relatively long time after being launched. In this way, even in a case where the electric power in the EDLC 302 is used, the number of times to charge the EDLC 302 will be smaller. This makes it possible to efficiently execute the maintenance process.

### Advantageous Effects

As described above, the printing apparatus 10 performs the switching process at a timing at which a setting can be configured with the user's input and the maintenance process needs to be executed. In this switching process, in a case where the value of electric power supplied through a USB cable is more than or equal to the first value and less than the second value, the input setting process mode is launched after the maintenance process is finished. This reduces the number of times to charge the EDLC 302 and makes it possible to efficiently execute the maintenance process. Also, in a case where it is determined that the value of electric power supplied through the USB cable is more than or equal to the second value, the maintenance process is executed after the input setting process mode is launched. This makes it possible to simultaneously execute the processes to be executed in the input setting process mode and the maintenance process. Accordingly, it is possible execute the input setting process during the maintenance process and efficiently execute these two processes.

### Other Embodiments

Note that the above embodiment may be modified as described in (1) to (6) below.

(1) In the above embodiments, a process implemented by multiple operations involving driving is described as the maintenance process, and but is not limited to this. The process implemented by multiple operations involving driving may be, for example, a process of initializing the home position of the carriage 406 (print head 404), a process of performing preliminary ejection from the print head 404, a process of initializing the conveyance motor 420, and the like at booting of the printing apparatus 10.

For example, the printing apparatus 10 is provided with a detection part (not illustrated), such as a linear encoder, for example, as a component for detecting the position of the carriage 406 (print head 404) in its moving direction (X direction). The printing apparatus 10 is also provided with a sensor (not illustrated) that detects the rotation of the conveyance motor 420. Thus, the process of initializing the home position of the carriage 406, is implemented by multiple operations involving driving such as an operation of moving the carriage 406 and a detection operation with the detection part, for example. Also, the process of performing preliminary ejection from the print head 404 is a process of performing ink ejection from the print head 404 that does not contribute to printing, and is implemented by multiple operations involving driving such as an operation of moving the carriage 406, an operation of moving the cap part 422, and a suction operation with the suction part, for example. Further, the process of initializing the conveyance motor 420 is implemented by multiple operations involving driving such as an operation of driving the conveyance motor 420 and a detection operation with a sensor.

(2) In the above second embodiment, after it is determined in S906 that the value of electric power obtained in S902 is not more than or equal to the second value, it is determined whether it is possible to communicate with the supply source of the electric power through a USB cable, but the process is not limited to this. For example, whether it is possible to communicate with the supply source of the electric power through the USB cable may be determined after it is determined in S904 that the value of electric power obtained in S902 is more than or equal to the first value. If it is determined that it is possible to communicate with the supply source through the USB cable, a flag for determining whether to launch the connection setting process mode is turned on. If it is determined that it is not possible to communicate with the supply source through the USB cable, the flag is turned off. Then, in S904, it is determined whether or not the value of electric power obtained in S902 is more than or equal to the second value. After this determination, the connection setting process mode is launched according to whether the flag is on or off. Specifically, the connection setting process mode is launched if the flag is on, and the connection setting process mode is not launched if the flag is off.

(3) Though not particularly described in the above third embodiment, if it is determined in S1006 that the value of electric power is not more than or equal to the second value, the CPU 216 may determine whether it is possible to communicate with the supply source of the electric power through a USB cable as in S912. In this case, if it is determined that it is not possible to communicate with the supply source of the electric power through the USB cable, the process proceeds to S1012. If it is determined that it is possible to communicate with the supply source of the electric power through the USB cable, the maintenance process is executed, and the switching process is terminated once the maintenance process is finished.

(4) In the above embodiments, the printing apparatus 10 is a so-called serial scan-type printing apparatus using a print head that ejects inks while moving in a direction crossing the conveyance direction of a print medium, but the present invention is not limited to this. The printing apparatus 10 may be a so-called full line-type printing apparatus using a long print head extending over the entire print area of a print medium in the width direction.

(5) Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

(6) The various configurations described in the above embodiment and (1) to (5) above may be combined as appropriate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-176524, filed Oct. 12, 2023, which is hereby incorporated by reference wherein in its entirety.

What is claimed is:

1. A printing apparatus capable of operating with electric power supplied through a USB cable, the printing apparatus comprising:
an obtaining unit configured to obtain information on a value of electric power supplied through the USB cable; and
a control unit configured to control execution of a first process and a second process based on the information obtained by the obtaining unit, the first process being a process to be implemented by a plurality of operations that are executed using a driving force from a driving source transmitted through a mechanical mechanism, the second process being a process related to a setting.

2. The printing apparatus according to claim 1, wherein based on the information, the control unit switches between first control in which the first process and the second process are simultaneously executed, and second control in which the second process is executed after the first process is finished,

3. The printing apparatus according to claim 2, wherein
the information is a value of electric power, and
the control unit
is capable of simultaneously executing the first process and the second process in a case where the value of electric power is more than or equal to a threshold value, and
executes the second process after finishing the first process in a case where the value of electric power is less than the threshold value.

4. The printing apparatus according to claim 3, further comprising:
a printing unit configured to perform printing by ejecting an ink onto a print medium; and
a maintenance unit configured to be capable of executing a maintenance process of maintaining or restoring ink ejection performance of the printing unit, wherein
the first process is the maintenance process.

5. The printing apparatus according to claim 4, further comprising a connection unit configured to wirelessly connect to an external apparatus, wherein
the second process is a process of wirelessly connecting to the external apparatus with the connection unit.

6. The printing apparatus according to claim 5, wherein
the external apparatus supplies electric power to the printing apparatus through the USB cable, and
the control unit executes the second process depending on whether it is possible to communicate with the external apparatus through the USB cable in the case where the value of electric power is less than the threshold value.

7. The printing apparatus according to claim 6, wherein
in the case where the value of electric power is less than the threshold value, the control unit
executes the second process after finishing the first process if it is impossible to communicate with the external apparatus through the USB cable, and
executes only the first process if it is possible to communicate with the external apparatus through the USB cable.

8. The printing apparatus according to claim 5, wherein the process of wirelessly connecting to the external apparatus with the connection unit includes a process of supplying electric power to the connection unit.

9. The printing apparatus according to claim 1, further comprising an electric power storage unit configured to be capable of storing electric power supplied through the USB cable, wherein
the printing apparatus is further capable of operating with electric power stored in the electric power storage unit.

10. The printing apparatus according to claim 1, further comprising:
a conveyance unit configured to convey a print medium; and
a printing unit configured to perform printing by ejecting an ink onto the print medium conveyed by the conveyance unit while moving relative to the print medium in a first direction crossing a conveyance direction of the print medium, wherein
the first process is a process of initializing a home position of the printing unit in the first direction.

11. The printing apparatus according to claim 1, further comprising:
a printing unit configured to perform printing by ejecting an ink onto a print medium; and
a cap unit configured to be capable of capping the printing unit, wherein
the first process is a preliminary ejection process by the printing unit which is ink ejection that does not contribute to printing.

12. The printing apparatus according to claim 1, further comprising:
a conveyance unit configured to convey a print medium; and
a driving motor that drives the conveyance unit, wherein
the first process is a process of initializing the driving motor.

13. The printing apparatus according to claim 1, further comprising an operation unit configured to be capable of displaying an input screen for configuring a setting with an input, and configured to be capable of accepting an input via an operation, wherein
the second process is a process for configuring a setting with an input.

14. The printing apparatus according to claim 13, wherein the process of configuring a setting with an input includes a process of displaying the input screen on the operation unit.

15. A method of controlling a printing apparatus capable of operating with electric power supplied through a USB cable, the method comprising:
obtaining a value of electric power supplied through the USB cable; and
controlling execution of a first process and a second process based on the value of electric power obtained in the obtaining, the first process being a process to be implemented by a plurality of operations that are executed using a driving force from a driving source transmitted through a mechanical mechanism, the second process being a process related to a setting.

16. A non-transitory computer readable storage medium storing a program for causing a computer to perform a control method, the control method being a method of controlling a printing apparatus capable of operating with electric power supplied through a USB cable, the control method comprising:
obtaining information on a value of electric power supplied through the USB cable; and
controlling execution of a first process and a second process based on the value of electric power obtained in the obtaining, the first process being a process to be implemented by a plurality of operations that are executed using a driving force from a driving source transmitted through a mechanical mechanism, the second process being a process related to a setting.
